(19) United States
(12) Patent Application Publication
(10) Pub. No.: US 2003/0061583 A1
(43) Pub. Date: Mar. 27, 2003

(54) Shape and look-up table based design rule checking (DRC) for physical verification of integrated circuit layouts

(75) Inventor: Vinod K. Malhotra, San Jose, CA (US)

Correspondence Address: NUMERICAL, C/O BEVER HOFFMAN & HARMS, LLP, 2099 GATEWAY PLACE, SUITE 320, SAN JOSE, CA, 95110-1017, US

(73) Assignee: Numerical Technologies, Inc., San Jose, CA

(21) Appl. No.: 09/953,376

(22) Filed: Sep. 14, 2001

(51) Int. Cl. G06F 17/50

(52) U.S. Cl. 716/5; 716/19

(57) ABSTRACT

Design rule checking (DRC) can be applied to a mask layout using a shape-based system. A shape includes a set of associated edges in a specified configuration. Design rules can then be based on various shapes, advantageously enabling efficient formulation and precise application of design rules. A concurrent processing methodology can be used to minimize processing overhead during this rule application. Design rules can also be incorporated into a lookup table (LUT) to further reduce DRC runtime by substantially minimizing the number of times a design rule must actually be calculated. A LUT can also improve DRC runtime for edge-based, concurrent processing DRC systems. A DRC system can also be connected to a network across which design rules and mask layout data files can be accessed and retrieved.

### FIELD OF THE INVENTION

The invention relates to the field of integrated circuit design verification, and more particularly to a system for verifying a mask layout using design rule checking.

### BACKGROUND OF THE INVENTION

Masks are used in the production of integrated circuits (ICs) to transfer a circuit layout (“IC layout”) onto a receiving substrate, such as a silicon wafer. A mask is typically a glass plate covered by a thin chrome layer, in which the IC layout is etched. A source of light or radiation is used to expose this mask pattern (“mask layout”) onto a layer of sensitive resist on the surface of the wafer. The top surface of the wafer is then chemically etched away in the areas not covered by the resist, thereby completing the transfer of the original IC layout onto the wafer. This transference process is known as lithography.

Lithography is a critical step in the IC manufacturing process. The accuracy with which the layers of patterned semiconductor material (doped silicon, oxide, metal, etc.) that make up an IC are formed significantly affects both process yield and IC performance. Therefore, the mask layout must be properly designed to ensure acceptable lithography results. To help ensure that a mask will be formed and perform as desired, a layout verification operation is performed prior to actual mask production. This layout verification is governed by a set of design rules (“rule deck”) that embodies the manufacturability requirements for production of the mask. Accordingly, this layout verification operation is commonly referred to as design rule checking (DRC).

Although the complex patterns of a mask layout may seem to be made up of fine lines, even the thinnest of lines can be represented by a series of contiguous edges, joined to other edges at distinct vertices to form polygons. Conventional DRC systems operate by applying the rule deck to the edges of the polygons in a mask layout. The design rules in the rule deck are typically based upon the length of an edge and its spacing from, or position relative to, other edges. These edges may belong to one or more mask layouts. Upon completion of the DRC operation, a report file of all the rule violations is generated, often including a graphical representation of the violations placed on the mask layout.

FIG. 1 shows a process flow diagram for a DRC operation performed on a mask layout by a conventional DRC tool. In step 101, a rule is selected from a predefined rule deck. Then in step 102, the mask layout data (from a single layer or multiple layers of an IC layout) is loaded into the DRC tool. In step 103, the geometry of the mask layout data is completely scanned, and every edge within the mask layout data is checked using the selected rule. Any edges violating that rule are then marked in step 104.

If there are additional rules in the rule deck (step 105), the process loops to step 101, where the next rule is selected. The rule application process continues in this manner until the entire rule deck has been exhausted, and the final report of rule violations is output in step 106.

The DRC operation shown in FIG. 1 is sometimes referred to as “sequential processing” due to the serial nature of the verification process. Sequential processing is used in all conventional DRC tools, such as those manufactured by Cadence, Mentor, and Avanti, and ensures that all the DRC rules are applied in a comprehensive manner. However, the iterative nature of sequential processing (i.e., select rule, load layout data, apply rule, select new rule, load layout data, apply new rule, etc.) means that there is a great deal of redundancy associated with conventional DRC operations. Because the layout data is continually being passed back and forth by the system, even relatively simple DRC operations can require lengthy runtimes and consume significant computing resources. Furthermore, because every layout edge is checked by almost every rule, the runtime for conventional DRC operations increases substantially linearly with increases in the number of rules being applied. Therefore, in a conventional DRC tool, a tradeoff must be made between design fidelity (i.e., a higher number of rules) and DRC efficiency (i.e., shorter processing times).

Conventional DRC tools are also limited by their use of edge-based algorithms, which can be too simplistic to effectively provide verification for complex layouts. For example, it may be desirable to check edges that have similar properties with different design rules. FIG. 2a shows a layout feature 210, sometimes referred to as a “finger”, which is common in mask layouts. Fingers often represent critical features in the final IC, and must be carefully verified to ensure proper mask production. Therefore, during a DRC operation, the design rules applied to edge 211 of feature 210 would check to make sure that edge 211 was properly sized and appropriately positioned relative to adjacent layout features.

FIG. 2b shows a second layout feature 220 that includes an edge 221. Edge 221 may have the same length and spacing as edge 211 in FIG. 2a, but it may be desirable to impose different design rules on the two edges. For example, feature 220 could be a non-critical feature able to tolerate some deviation from the mask layout specification, while feature 210 could be a much more important feature requiring accurate sizing and placement for proper IC function. It would therefore be beneficial to be able to distinguish between the two features, so that each edge could be checked by an appropriate design rule. However, an edge-based system generally would not be able to distinguish between edges 211 and 221, and therefore would not be able to apply different design rules to features 210 and 220.

Accordingly, it would be desirable to provide a system for efficiently performing a DRC operation while enabling greater flexibility and control in applying design rules.

### SUMMARY OF THE INVENTION

The present invention provides a system for efficiently performing DRC operations on a mask layout (or a portion of a mask layout). In accordance with an embodiment of the invention, a DRC system uses a rule deck in which the design rules are based on shapes rather than single edges. A shape can be defined as a set of associated edges. Therefore, a shape can provide much greater specificity than a single edge in identifying layout features of interest. A catalog of shapes can be defined and design rules can be formulated based on the properties of the various shapes. Shapes can include various contiguous edge profiles, such as fingers and tombstones, among others. Shapes can also include non-contiguous edge combinations, edges from multiple layers of an IC layout, and edges with specific properties.

In accordance with an embodiment of the invention, a shape-based DRC system can use a sequential processing algorithm, like conventional edge-based DRC systems. The use of shape-based rules enables design rules to be defined and applied with greater specificity.

In accordance with another embodiment of the invention, a shape-based DRC system can use a concurrent processing algorithm. In contrast to conventional sequential processing systems, a concurrent processing system applies the entire set of DRC rules to each mask layout polygon in a single pass. The mask layout is therefore scanned just once, and the overhead associated with sequential processing due to the passing back and forth of intermediate layout data can be eliminated.

In accordance with another embodiment of the invention, the rule deck for a concurrent processing DRC system can be compiled in a look up table (LUT). A LUT is typically used to reduce processing times for applications involving the selection of a particular item from a large set of options. Because a table lookup can generally be performed substantially faster than a linear search for the applicable rule, use of a LUT significantly reduces the total time required for a DRC operation over conventional DRC systems. A LUT is therefore particularly beneficial in a concurrent processing system (whether edge- or shape-based) due to the batch nature of the algorithm.

According to an embodiment of the invention, a DRC system includes an input data manager for receiving a layout data file, a DRC engine for applying the design rules to the layout, and an output data manager for generating the final DRC results. In an embodiment of the invention, layout data files and design rules can be stored and accessed across a network, such as a LAN or a WAN. According to another embodiment of the invention, the input data manager can process and structure the layout data file for optimal processing by the DRC engine.

In accordance with another embodiment of the invention, a mask includes groups of layout features where portions of those layout features have similar edge arrangements but different tolerance ranges.

In accordance with another embodiment of the invention, an IC includes multiple patterned layers, and at least one of the patterned layers includes groups of layout features where portions of those layout features have similar edge arrangements but different tolerance ranges.

The invention will be more fully understood in view of the following description and drawings.

### BRIEF DESCRIPTION OF THE DRAWINGS

FIG. 1 is a process flow diagram for a conventional DRC operation;

FIGS. 2a and 2b illustrates mask layout features that have similar appearances but can require the application of different design rules;

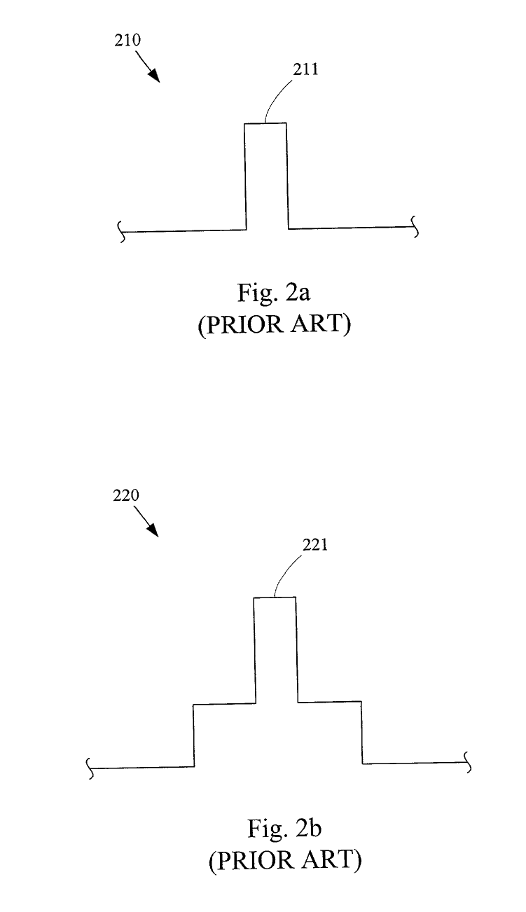

FIG. 3 illustrates a portion of a mask layout including two distinct features;

FIGS. 4a, 4b, and 4c illustrate sample shapes in a shape-based that may be incorporated into a design rule deck of the invention;

FIGS. 5a and 5b illustrate sample shapes comprising non-contiguous edges;

FIG. 5c illustrates an example of a branching mask layout feature;

FIGS. 6a-6c illustrate mask layout features that differ from each other only in certain regions;

FIG. 6d illustrates a shape having an indeterminate section that provides wildcard functionality;

FIG. 7a is a process flow diagram of a shape-based DRC operation using sequential processing;

FIG. 7b is a process flow diagram of a DRC operation using concurrent processing;

FIG. 8 is a process flow diagram of a concurrent processing DRC operation incorporating a LUT;

FIG. 9 illustrates a schematic diagram of a DRC system; and

FIG. 10 illustrates an embodiment of a DRC system including access to remote design rule and layout databases.

### DETAILED DESCRIPTION

An embodiment of the invention provides a system and method for performing a DRC operation on a mask layout using a shape-based approach. The shape-based approach advantageously enables accurate and efficient application of the design rules used in the DRC operation.

Shape Definition

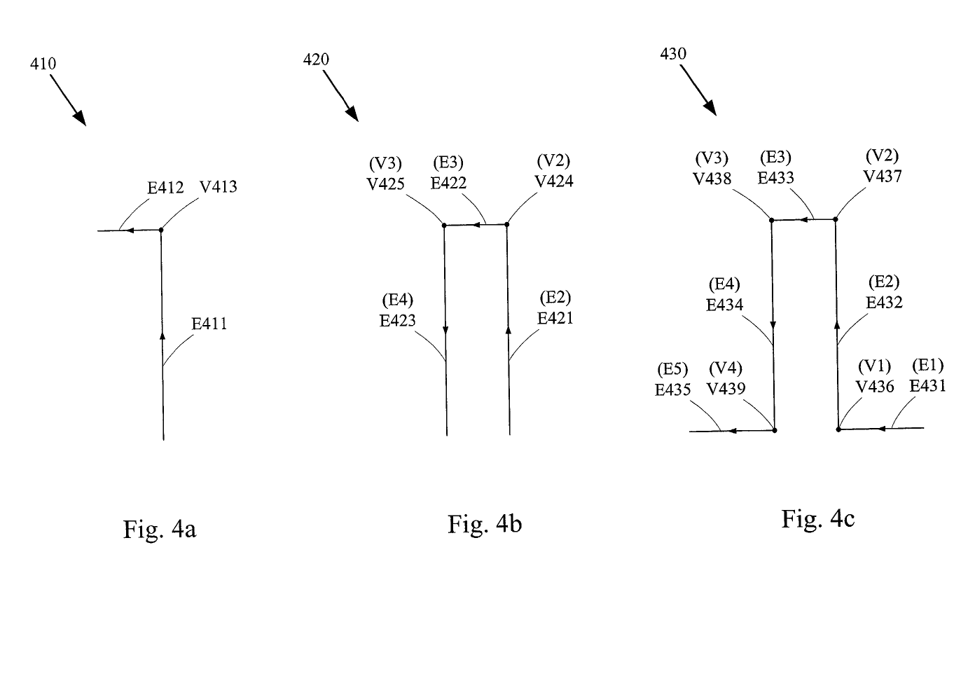

In accordance with embodiments of the invention, design rules can be based on various “shapes” —essentially groupings of associated directed edges and vertices. The direction of an edge determines which side (left or right) of the edge faces the inside or outside of the shape. For example, the left side of the counter-clockwise directed edges shown in FIGS. 4a-4c faces the inside of the corresponding shapes. A vertex is a corner or a point where two directed edges meet.

Each shape represents a type of feature (or range of features) that may be present in a mask layout. A set of shape properties defines the relationships between the edges and vertices that make up the shape. Example properties in accordance with various embodiments of the invention include the following:

Color—A tagging mechanism to differentiate one mask layout (or a portion of it) from another, based on certain attributes. For example, the polysilicon layer can be assigned one color whereas the diffusion layer can be assigned another color. Furthermore, the inside of a shape can have one color (“inner color”) while the outside of a shape can have a different color (“outer color”).

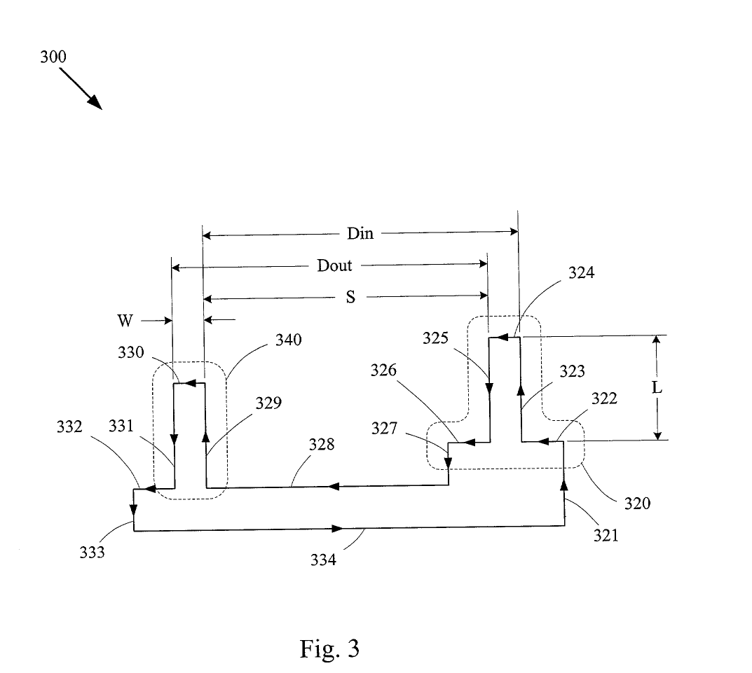

Width—The orthogonal distance between two inside facing edges. For example, in FIG. 3, edges 329 and 331 have a width W. If the orthogonal distance between the edges varies, both a “minimum width” and a “maximum width” can be defined.

Neighbor Width—The width of the immediate neighboring feature facing an outside edge. For example, in FIG. 3, the neighbor width for edge 327 is ‘W’, the distance between edges 329 and 331.

Spacing—The orthogonal distance between two outside facing edges. For example, in FIG. 3, edges 325 and 329 have a spacing S. If the orthogonal distance between the edges varies, both a “minimum spacing” and a “maximum spacing” can be defined.

Radial Spacing—The radial distance between two outside facing edges. If the radial distance between the edges varies, both a “minimum radial spacing” and a “maximum radial spacing” can be determined.

Angle—The angle at which two connected edges meet. For example, in FIG. 4c, edges E431 and E432 meet at vertex V436 at an angle of 90 degrees. Similarly, edges E432 and E433 meet at vertex V437 at an angle of 270 degrees.

Length—An edge property that represents the length of the edge. For example, in FIG. 3, edge 323 has a length L.

Inner Distance—It is the distance from the inside facing edge of one shape to the outside facing edge of another shape. For example, in FIG. 3, the edge 323 of shape 320 has an inner distance Din from edge 329 of shape 340. If the distance between the edges varies, both a “minimum inner distance” and a “maximum inner distance” can be defined.

Outer Distance—It is the distance from the outside facing edge of one shape to the inside facing edge of another shape. For example, in FIG. 3, the edge 325 of shape 320 has an outer distance Dout from edge 331 of shape 340. If the distance between the edges varies, both a “minimum outer distance” and a “maximum outer distance” can be defined.

Note that this listing is intended to be exemplary rather than comprehensive. Other properties will be readily apparent.

FIG. 3 shows a sample polygon 300 from a larger mask layout (not shown). The outline of polygon 300 has been selected for explanatory purposes only. The shape-based methodology may be applied to any configuration of edges in a mask layout. Polygon 300 comprises a series of contiguous edges 321-334. Typically, a mask layout can be separated into individual polygons. Polygon 300 includes a feature 320, comprising edges 322-326, and a feature 340, comprising edges 329-331. Edges 323-325 in feature 320 form a grouping having a substantially similar edge arrangement to feature 340.

Features in a mask pattern must generally fall within specified dimensional tolerances. If features 320 and 340 represent an interconnect and an active area of a transistor, respectively, greater dimensional deviation from the mask layout would generally be allowed for feature 320 than would be allowed for feature 340. Therefore it would be desirable to apply a stricter design rule to feature 340. However, a conventional edge-based DRC system would be unable to distinguish between edge 324 of feature 320 and edge 330 of feature 340, and would have to apply the same design rule to both. In contrast, a shape-based DRC system could identify features 320 and 340 as different shapes, thereby enabling the application of appropriate design rules to each. Consequently, a shape-based DRC system would enable the production of masks (and ICs from those masks) having layout features with similar edge arrangements but different design rules (e.g., layout features corresponding to transistor elements having stricter design rules than layout features corresponding to interconnects).

FIGS. 4a-4c provide examples of some other shapes that might be used in a shape-based DRC system. FIG. 4a shows a shape 410 comprising an edge E411 and an edge E412 joined at a vertex V413. FIG. 4b shows a shape 420 comprising an edge E421 joined at a vertex V424 to an edge E422, which in turn is joined at a vertex V425 to an edge E423. Finally, FIG. 4c shows a shape 430 that comprises contiguous edges E431-E435, which are joined at vertices V436-V439, respectively.

Although geometrically simple, shapes 410, 420, and 430 can present problems for conventional DRC systems. Edge-based systems can have difficulty differentiating between edges E412, E422, and E433 in FIGS. 4a, 4b, and 4c, respectively, since the edges “look” similar in each configuration. In contrast, the shape-based approach of the invention allows each one of the edges E412, E422 and E433 to be clearly distinguished without confusion. The utility of a shape-based system increases for more complex layout features.

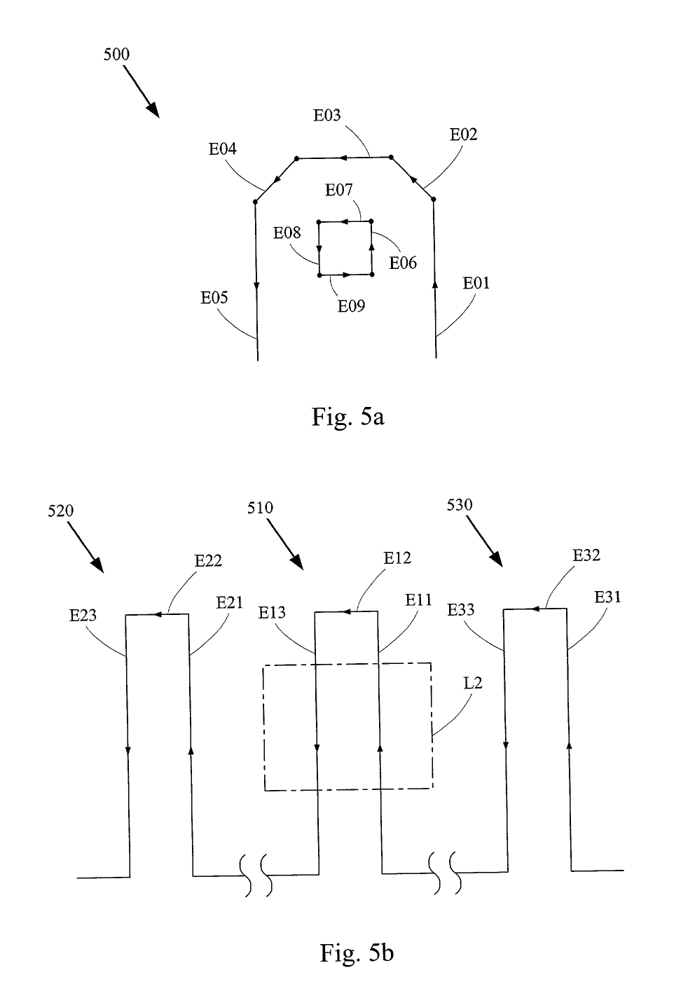

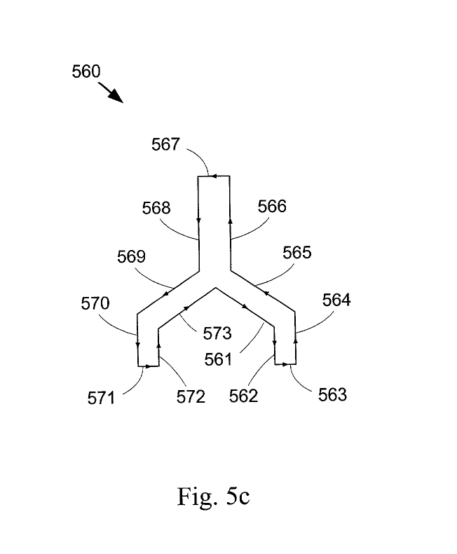

According to another aspect of the invention, a shape may include non-contiguous edges. For example, FIG. 5a shows a shape 500 comprising edges E01-E09. Edges E01-E05 are contiguous, forming a “tombstone” feature that is physically disconnected from contiguous edges E06-E09. The use of only contiguous edges E01-E05 to define a shape would require the formulation of additional rules to detect the presence of a feature like that formed by edges E06-E09 within the shape. In addition to the difficulties associated with this rule generation, the additional rules would also consume greater processing resources, since each feature matching a shape formed by edges E01-E05 would have to be checked for the presence of an interior feature. These problems could be avoided through the use of shape 500, which already includes the proper interior elements, thereby enabling direct identification of only the desired features.

According to another aspect of the invention, a shape may include edges from different layers of an IC layout. Frequently, different layers of an IC layout represent different process steps in the manufacture of the IC. FIG. 5b shows IC layout features 510, 520, and 530, which are part of a single layer in a larger IC layout (not shown). Feature 510 comprises contiguous edges E11, E12, and E13, feature 520 comprises contiguous edges E21, E22, and E23, and feature 530 comprises contiguous edges E31, E32, and E33. Features 510, 520, and 530 are all similarly sized. However, only feature 510 is positioned over a feature L2, which is part of a different layer (not shown) of the IC layout.

Features 510, 520 and 530 might, for example, belong to poly-silicon layer, while feature L2 might represent a diffusion region, thereby indicating that feature 510 is to be used to form a transistor gate. As a critical device component, the printed image corresponding to feature 510 probably demands much greater accuracy than the printed images corresponding to features 520 and 530. Therefore, a shape may be defined that includes edges E11-E13 of feature 510, and also includes edges (or all) of feature L2. By defining a shape in this manner, critical features such as feature 510 can be readily distinguished from less critical features such as features 520 and 530.

FIG. 5c shows a branching shape 560 comprising edges 561-573 forming multiple extremities. This type of branching arrangement would be difficult to identify using conventional edge-based identification, due to the angular relationships of the edges and the multiple arms. However, by defining the entire collection of edges as a single shape, matching mask layout features can be readily identified. Mask layout features with any number of branches can be identified in a similar fashion.

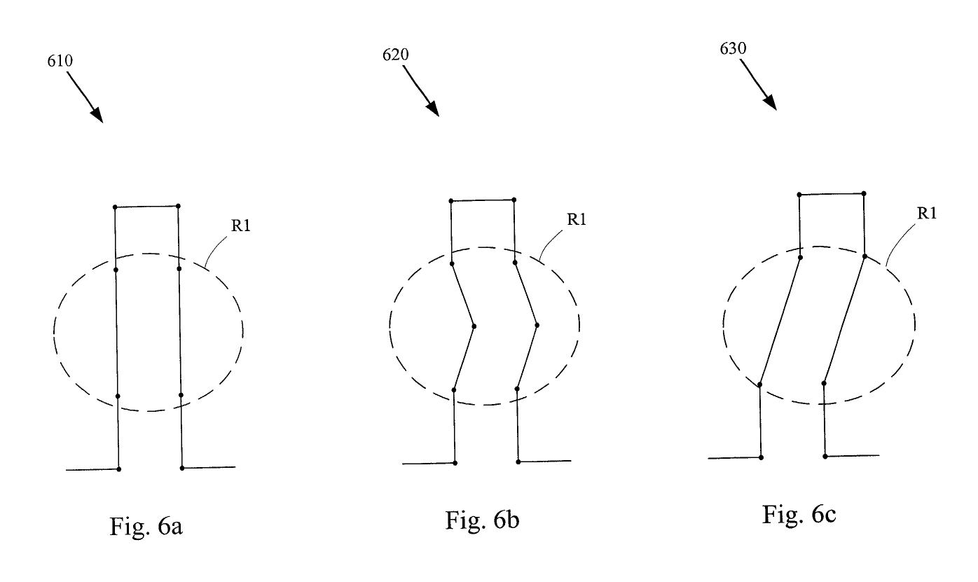

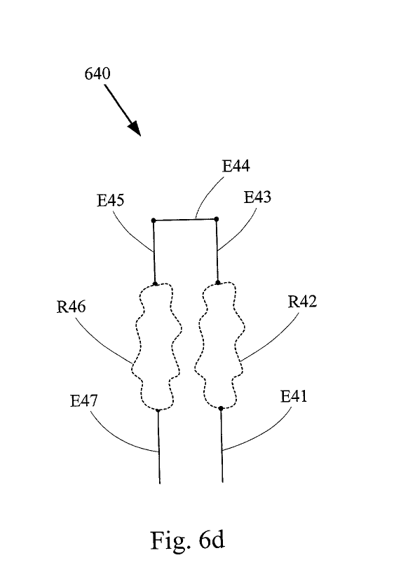

FIGS. 6a, 6b, and 6c show layout features 610, 620, and 630, respectively. Features 610, 620, and 630 significantly differ only in indicated regions R1, R2, and R3, respectively. Therefore, one shape with “wildcard” functionality could be used to identify all of features 610, 620, and 630. Specifically, in accordance with another aspect of the invention, a shape may include a “wildcard” property (or properties), wherein the wildcard property represents multiple alternative relationships between certain edges. A wildcard property therefore allows a single shape to identify a range of actual layout features. For example, FIG. 6d shows a shape 640 comprising edges E41, E43-E45, and E47, and indeterminate regions R42 and R46. Edges E43-E45 are contiguous, while edges E41 and E43 are coupled by indeterminate region R42, and edges E45 and E47 are coupled by indeterminate region R46. Indeterminate region R42 may be defined as any linkage between edges E41 and E43. Similarly, region R46 may be defined as any linkage between edges E45 and E47. Indeterminate regions R42 and R46 therefore allow shape 640 to match any layout feature having edges E41, E43-E45, and E47, regardless of how those edges are coupled. Additional limitations on the regions as a whole (length, width, number of included edges, etc.) and on individual edges within the regions (length, color, orientation, etc.) may be imposed to restrict the potential range of shapes matched by shape 640. For example, regions R42 and R46 might be limited to a single line segment thus enabling shape 640 to match shapes 610 and 630 shown in FIGS. 6a and 6c, respectively, but not match shape 620 shown in FIG. 6b.

Shape Matching and Design Rule Application

Once the shapes have been determined, design rules may be formulated based on those shapes and their property variables (such as those listed previously). Of course, a rule deck can include both shape-based and edge-based design rules. The shape definitions and/or design rules may be provided as defaults by the system, or can be partially or fully defined by a user. In an embodiment of the invention, a graphical user interface (GUI) can be provided to allow the user to input custom shapes and design rules. In another embodiment of the invention, a predetermined shape/design rule file may be loaded from an external source.

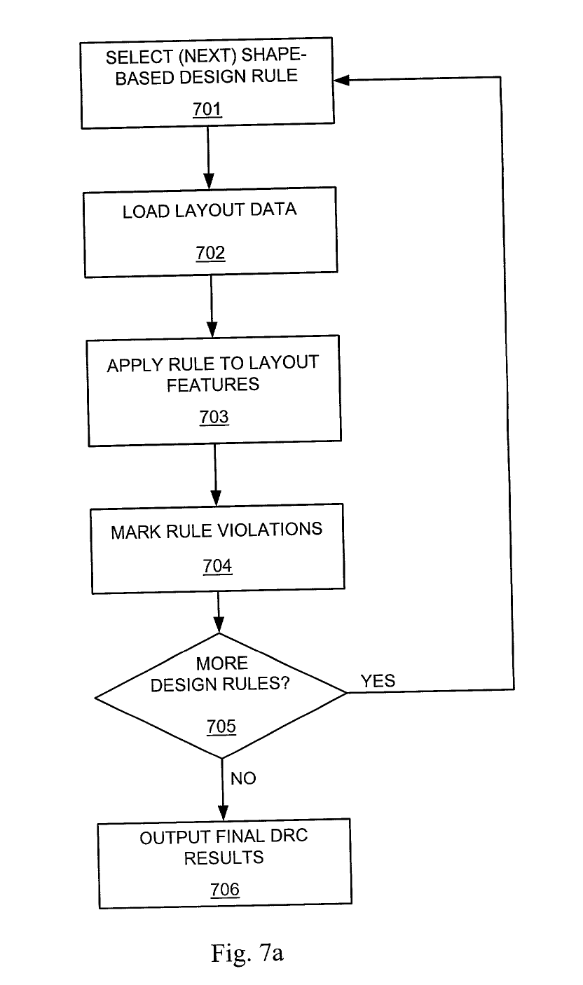

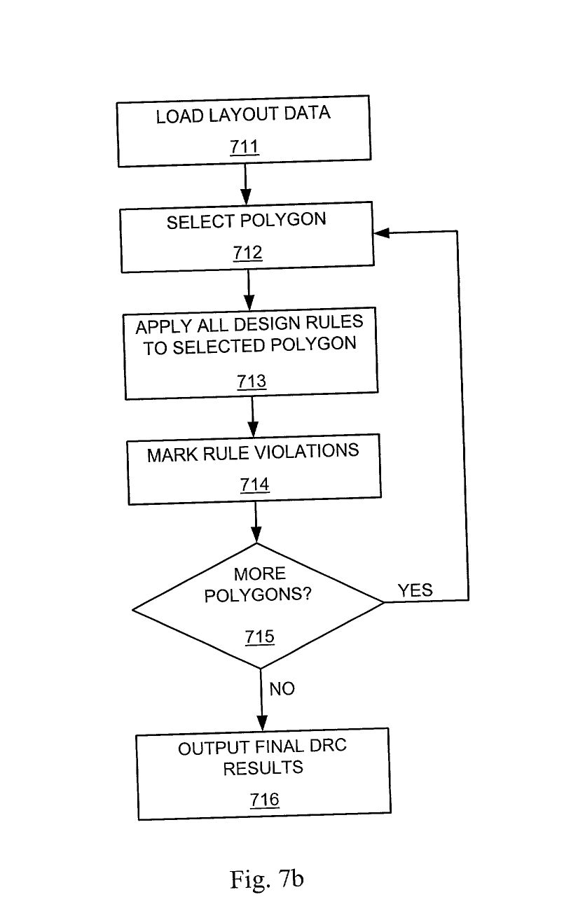

According to an embodiment of the invention, the design rules can then be applied to a mask layout using a sequential processing algorithm, as shown in FIG. 7a. In step 701, a shape-based design rule is selected from a predefined rule deck. In step 702, the appropriate mask layout data is loaded into the DRC system. For example, some DRC commands may require only one layer of the IC layout, while others may require 2 or 3 layers. Therefore, in step 702, only those layers that are required by the design rule selected in step 701 need be loaded.

Then, in step 703, the features within the mask layout are checked using the selected rule, and any rule violations are marked in step 704. If there are additional rules in the rule deck (step 705), the process loops to step 701, where the next rule is selected and the iterative process continues. Note that the actual rule application performed in step 703 can involve checking each layout feature, or checking only those features that have not been previously marked (i.e., only those features that have not violated a previously applied design rule). While checking every feature can provide a comprehensive indication of all layout errors, checking only the unmarked features can provide a significant time savings by reducing the total number of rule calculations.

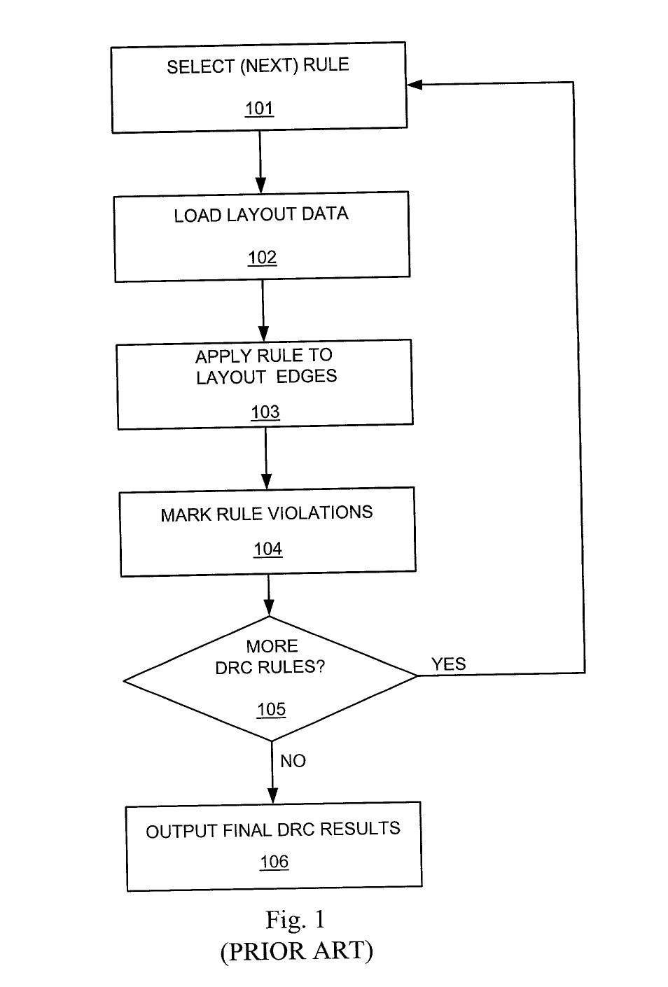

After the entire rule deck has been exhausted, the final report of rule violations is output in step 706. Note that in contrast to the conventional edge-based DRC process shown in FIG. 1, the DRC process shown in FIG. 7a incorporates design rules that are based on, and are used to check, edge groupings (i.e., shapes) rather than single edges, and therefore provides much more versatile and accurate layout verification capability.

According to another embodiment of the invention, the shape-based design rules can be applied to a mask layout using a concurrent processing algorithm, as shown in FIG. 7b. In step 711, the mask layout data is loaded into the DRC system. Depending on the state of the mask layout data, the loading operation performed in step 711 can include manipulation of the input data. For example, the original mask layout data may have been a “fractured” data file (i.e., the polygons of the mask layout may have been broken into layout primitives such as rectangles or trapezoids, such as in an e-beam tooling file). In that case, the loading operation of step 711 would involve reassembling the fractured primitives into complete polygons. Similarly, the input mask layout data file might have a file format different than that used by the DRC algorithm. In such a case, step 11 would have to incorporate a format translation operation.

Once the mask layout data has been input and properly processed, a first polygon is selected in step 712. In step 713, the entire rule deck is applied to the selected polygon, with any rule violations being noted in step 714. According to an embodiment of the invention, the rule application of step 713 is performed by scanning the polygon in a counter clockwise direction, matching the edges and vertices making up the polygon against the pre-defined shapes in the rule deck. Accordingly, multiple shapes can match features within the polygon as this scanning progresses.

According to an embodiment of the invention, checking of a feature within a polygon is stopped once a rule violation is detected for that feature. Therefore, all the rules in the rule deck may not necessarily be applied to a given feature, and the design rules must be ordered to account for this constraint. For example, design rules relating to critical layout elements may be placed at the beginning of the rule deck to ensure that any violations of those critical rules are flagged first. Alternatively, the design rules most likely to be violated can be placed at the head of the rule deck to optimize overall DRC runtime.

According to another embodiment of the invention, a given feature is checked by all design rules irrespective of the detection of a rule violation, and the final DRC results lists all of the resulting rule violations. If there are more polygons to be examined, step 715 loops the process back to step 712, where the next polygon is selected, and the rule application process continues. After the design rules have been applied to all the polygons in the mask layout, the final DRC results are output in step 716.

Because the entire rule deck is applied to each layout feature as it is selected, the concurrent processing algorithm shown in FIG. 7b will typically be more computationally efficient than the sequential processing algorithm shown in FIG. 7a. A concurrent processing system eliminates the processing overhead associated with rescanning the layout geometry for every design rule and reloading updated layout data after every rule application. Note that the concurrent process flow shown in FIG. 7b could be used with either a shape-based or edge-based rule deck.

According to another embodiment of the invention, the performance of a concurrent processing system can be significantly improved by employing a lookup table (LUT). Incorporating the rule deck into a LUT allows the concurrent rule application step to be performed as a simple table lookup, rather than a more time-consuming series of computations. Therefore, the size of the rule deck and/or the complexity in the mask layout can be increased without significantly increasing the total runtime of the DRC operation. In a conventional DRC system, runtime is essentially proportional to the size of the rule deck. Contrastingly, in a concurrent processing DRC system (either edge- or shape-based) that incorporates a LUT, an order of magnitude increase in the number of design rules will typically result in less than a 100% increase in runtime. While the use of a LUT does require that a small amount of time be spent to initialize the LUT at the beginning of the DRC operation, this time is insignificant compared to the time spent performing design rule calculations by a conventional DRC system during a DRC operation.

Table 1 is an example LUT that includes possible design rules for shapes 420 and 430, from FIGS. 4b and 4c, respectively. The table entries for shapes 420 and 430 differ in two ways. First, the rule for shape 430 includes the additional geometry that distinguishes itself from shape 420; i.e., edges E1 and E5 (corresponding to edges E431 and E435, respectively, in FIG. 4c) and their associated vertices V1 and V4. Second, the rule for shape 430 has a more stringent requirement than the rule for shape 420 on the length of edge E3 (corresponding to edge E422 in FIG. 4b and edge E433 in FIG. 4c). According to Table 1, if shape 430 is detected, edge E3 must be at least 0.15 μm in length, whereas if shape 420 is detected, edge E3 can be as short as 0.10 μm. This could be useful if, for example, a layout included many finger features but only those matching the profile of shape 430 had to be maintained at the greater width (for reliable functioning of the final IC).

TABLE 1
Sample Shape-Based Design Rules

| | E3 | E2, E4 | E1, E5 | V2, V3 | V1, V4 | |
|---|---|---|---|---|---|---|
| RULE | (μm) | (μm) | (μm) | (deg.) | (deg.) | RESULT |
| 430 | <0.15 | <1.5 | <1.0 | 270 ± 5 | 90 ± 5 | VIOLATION |
| 420 | <0.10 | <1.5 | — | 270 ± 5 | — | VIOLATION |

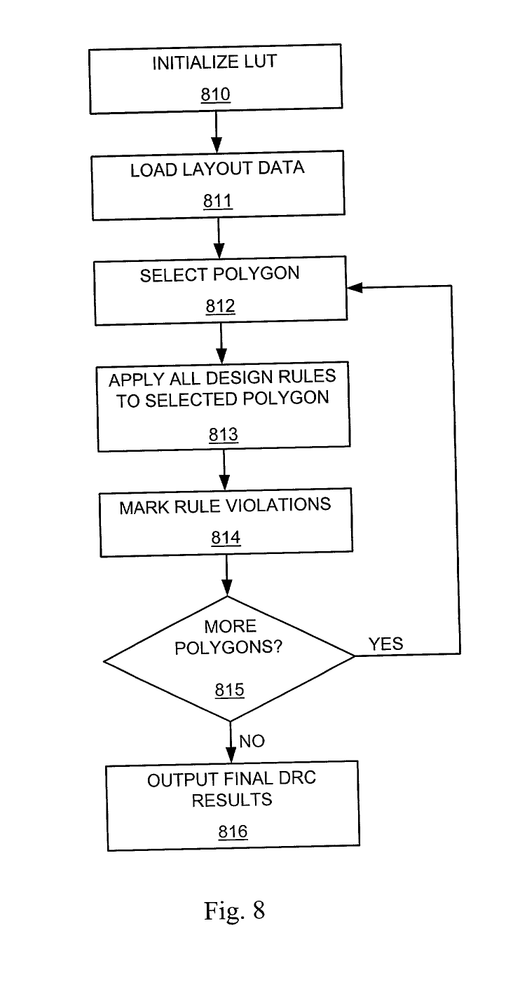

FIG. 8 shows a process flow diagram for a DRC operation making use of a LUT, in accordance with an embodiment of the invention. Note that the process flow shown in FIG. 8 could be applied to any concurrent processing DRC system, whether shape-based or edge-based. The concurrent processing algorithm depicted in FIG. 8a is similar to that shown in FIG. 7b. The only difference is that the process begins with the initialization of the LUT in step 810. A LUT is initialized prior to the actual running of the DRC operation to populate it with the proper values. According to an embodiment of the invention, “initialization” of a LUT can comprise the creation of the LUT from a set of design rules. According to another embodiment of the invention, the “initialization” can simply involve the loading of a predefined LUT into the DRC system, e.g. from a file or across a network.

According to an embodiment of the invention, the initialization of the LUT can be performed as soon as the DRC system is loaded. This immediate initialization would eliminate the need for initialization of the LUT during the actual DRC operation on a particular layout and provide maximum throughput. Alternatively, the LUT could be initialized at the start of every DRC operation, which would cause a slight increase in total runtime but ensure that any user modifications to the rule deck are properly incorporated. Once the LUT has been initialized, the DRC operation proceeds as described with respect to FIG. 7b (with steps 811-816 of FIG. 8 corresponding to steps 711-716, respectively, of FIG. 7b). However, note that step 813 (rule application, LUT-based) is more efficient than step 713 (rule application, no LUT) because it uses the LUT to quickly find the design rule that matches a given feature.

Shape-Based DRC System

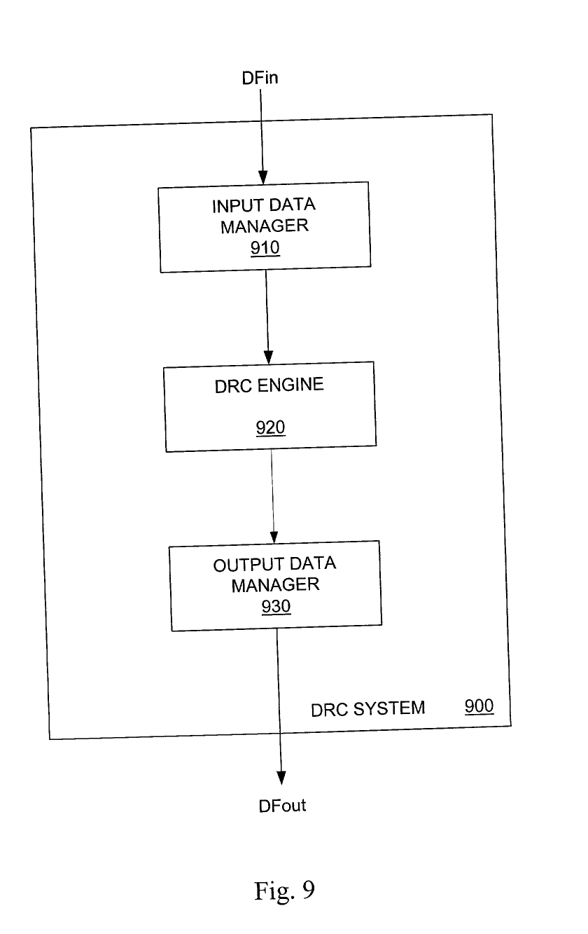

FIG. 9 shows a diagram of a DRC system 900 in accordance with an embodiment of the invention. DRC system 900 comprises an input data manager 910, a DRC engine 920, and an output data manager 930. Input data manager 910 is coupled to receive a mask layout data file DFin. Data file DFin can comprise an entire IC layout, or can comprise only layout data specific to a particular mask layout. According to an aspect of the invention, data file DFin may be a standard layout database file exchange format such as GDS, GDSII, DXF, CIF, IGES, a flat file, or even a proprietary database file format. More generally, any data file format that defines the geometry of a layout could be used.

Input data manager 910 converts data file DFin to a form that may be manipulated and processed by the DRC system. In an embodiment of the invention, input data manager 910 selects and organizes the layout data to be analyzed from within data file DFin. For example, data file DFin may need to be separated into various layers, only one of which will be actually printed on the mask. Also, input data manager 910 could “reassemble” the layout primitives of fractured data files into complete polygons. According to an embodiment of the invention, a user can configure the operational parameters of input data manager 910.

DRC engine 920 then performs a DRC operation on the layout data provided by input data manager 910. According to various embodiments of the invention, DRC engine 920 can incorporate a shape-based sequential processing system as described with respect to FIG. 7a, a concurrent processing system as described with respect to FIG. 7b, or a LUT-based concurrent processing system (either edge- or shape-based) as described with respect to FIG. 8.

After the layout data has been processed by DRC engine 920, it is fed to output data manager 930. The processed data can be converted by output data manager 930 into an output data file DFout. According to an embodiment of the invention, output data file DFout can be a report listing of all the rule violations detected by DRC engine 920. According to another embodiment of the invention, output data file DFout can be a graphical representation of the mask layout with the rule violations indicated thereon. In an embodiment of the invention, output data file DFout can be converted to the same layout data file format as input data file DFin. In another embodiment of the invention, a user may select a file format for data file DFout.

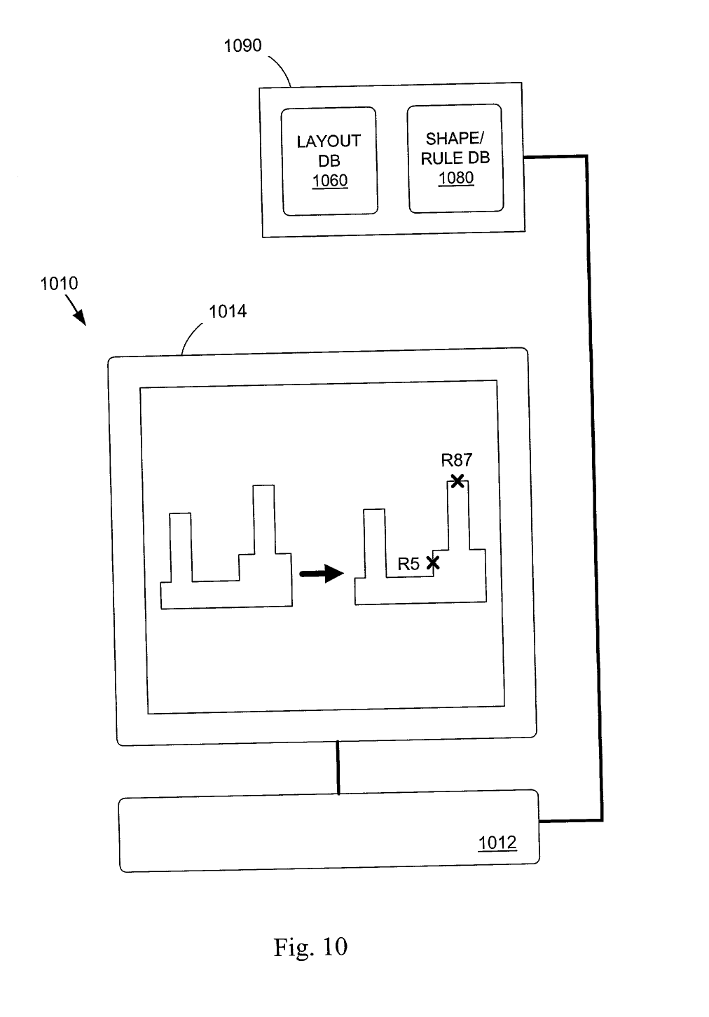

FIG. 10 provides a physical representation of DRC system 900 shown in FIG. 9, according to an embodiment of the invention. FIG. 10 shows a computer system 1010 comprising a processor 1012 and a graphical display 1014. Alternatively, computer system 1010 could include multiple processors. Computer system 1010 includes software to perform the operations described with reference to DRC system 900 in FIG. 9. Computer system 1010 could include a personal computer (PC) running Microsoft™ software and/or a workstation. Display 1014 allows a user to monitor, modify, and control the DRC process being performed by computer system 1010.

FIG. 10 also shows a layout database 1060 and a shape/rule database 1080, both of which may be located in a network storage location 1090 (apart from computer system 1010). Layout database 1060 stores mask layout data files, while rule database 1080 houses design rules for use in DRC operations. Alternatively, the layout data files and design rules could be stored locally in computer system 1010. Computer system 1010 may access layout database 1060 for files on which to perform DRC operations, and may access shape/rule database 1080 for appropriate design rules for the DRC operation. In an embodiment of the invention, databases 1060 and 1080 may be accessed through a local area network (LAN). In another embodiment of the invention, databases 1060 and 1080 may be accessed though a wide area network (WAN), such as the Internet.

Thus, an efficient and powerful technique for performing DRC operations is described. By using a shape-based identification system, seemingly similar layout features can be readily distinguished, and layout processing actions can be precisely applied. By incorporating design rules into a LUT, the time required to perform a DRC operation can be reduced. The above disclosure is not intended to be limiting. Numerous modifications and variations of the invention will be apparent. Therefore, the invention is limited only by the following claims.

I claim:

1. A method for performing a design rule checking (DRC) operation on a mask layout comprising a plurality of polygons, the method comprising:
selecting a first design rule from a rule deck, the first design rule being based on a first shape, the first shape comprising a first edge and a second edge related according to a defined property; and
applying the first design rule to a first one of the plurality of polygons.

2. The method of claim 1, wherein the first edge and the second edge are not contiguous.

3. The method of claim 1, wherein the defined property specifies a plurality of alternative relationships between the first edge and the second edge.

4. The method of claim 1, the second edge being contiguous with and substantially perpendicular to the first edge, and
wherein the first shape further comprises a third edge, the third edge being contiguous with and substantially perpendicular to the second edge, the third edge and the first edge being substantially adjacent and substantially parallel.

5. The method of claim 1, the second edge being contiguous with the first edge, and wherein the first shape further comprises:
a third edge, the third edge being contiguous with the second edge;
a fourth edge, the fourth edge being contiguous with the third edge; and
a fifth edge, the fifth edge being contiguous with the fourth edge, wherein:
the first edge and the fifth edge are substantially parallel;
the second edge forms an obtuse angle with the first edge;
the third edge is substantially perpendicular to the first edge, forms an obtuse angle with the second edge, and forms an obtuse angle with the fourth edge; and
the fourth edge forms an obtuse angle with the fifth edge.

6. The method of claim 5, wherein the first shape further comprises:
a sixth edge;
a seventh edge, the seventh edge being contiguous with the sixth edge;
an eighth edge, the eighth edge being contiguous with the seventh edge; and
a ninth edge, the ninth edge being contiguous with the eighth edge and the sixth edge, wherein:
the sixth, seventh, eighth, and ninth edges form a substantially rectangular outline; and
the sixth, seventh, eighth, and ninth edges are between, but not contiguous with, the first and fifth edges.

7. The method of claim 1, wherein the first shape forms a substantially branching arrangement.

8. The method of claim 1, wherein the first one of the plurality of polygons comprises a plurality of features, and
wherein if a first one of the plurality of features violates the first design rule, then the first one of the plurality of features is not checked with the remainder of the rule deck.

9. The method of claim 8, wherein the rule deck has a user-defined order.

10. The method of claim 8, wherein the rule deck is ordered according to design rule criticality.

11. The method of claim 1, further comprising:
applying the first design rule to the remainder of the plurality of polygons;
selecting a second design rule; and
applying the second design rule to the plurality of polygons.

12. The method of claim 1, further comprising:
applying the remainder of the rule deck to the first one of the plurality of polygons;
selecting a second one of the plurality of polygons; and
applying the rule deck to the second one of the plurality of polygons.

13. The method of claim 12, further comprising initializing a lookup table, the lookup table incorporating the rule deck.

14. The method of claim 12, wherein the first one of the plurality of polygons comprises a plurality of features, and
wherein if a first one of the plurality of features violates the first design rule, then the first one of the plurality of features is not checked with the remainder of the rule deck.

15. A method for performing a design rule checking (DRC) operation on a mask layout according to a plurality of design rules using a computer system, wherein the mask layout comprises a plurality of polygons, the method comprising:
initializing a look-up table (LUT) incorporating the plurality of design rules;
loading the mask layout into the computer system;
applying the plurality of design rules to a first polygon; and
applying the plurality of design rules to a second polygon.

16. The method of claim 15, wherein initializing the LUT comprises:
calculating results for each the plurality of design rules; and
creating the LUT using the plurality of design rules and the calculated results.

17. The method of claim 15, wherein initializing the LUT comprises loading a predefined LUT incorporating the plurality of design rules into the computer system.

18. The method of claim 15, wherein the plurality of design rules comprises a first design rule based on a first shape, the first shape comprising a first edge and a second edge related according to a defined property.

19. The method of claim 15, the plurality of design rules being having a defined sequence, and the first polygon comprising a plurality of features, wherein applying the plurality of design rules to the first polygon comprises:
selecting a first one of the plurality of features; and
checking the first one of the plurality of features with the plurality of design rules in the defined sequence,
wherein if the first one of the plurality of features violates a first one of the plurality of design rules, then the first one of the plurality of features is not checked with the remainder of the plurality of design rules.

20. The method of claim 19, wherein the defined sequence is based on design rule criticality.

21. A system for performing a design rule checking (DRC) operation on a mask layout data file, the system comprising:
an input data manager for loading the mask layout data file into the system;
a DRC engine for applying a plurality of design rules to the mask layout data file, wherein a first one of the plurality of design rules is based on a first shape, the first shape comprising a first edge and a second edge related according to a defined property; and
an output data manager for generating an output data file.

22. The system of claim 21, wherein the mask layout data file comprises a fractured data file, and wherein loading the mask layout data file into the system comprises reassembling a plurality of layout primitives into a plurality of polygons..

23. The system of claim 21, the mask layout data file comprising a plurality of layers, wherein loading the mask layout data file into the system comprises selecting at least one of the plurality of layers.

24. The system of claim 21, the mask layout data file having a first data file format, wherein loading the mask layout data file into the system comprises converting the first data file format into a second data file format, the DRC engine being configured to operate on the second data file format.

25. The system of claim 24, wherein generating the output data file comprises converting the second data file format into a third data file format.

26. The system of claim 25, wherein the third data file format is the same as the first data file format.

27. The system of claim 25, wherein generating the output data file further comprises allowing a user to select the third data file format from a plurality of data file formats.

28. The system of claim 21, wherein the DrC engine generates a listing of design rule violations, and wherein the output data file comprises a graphical representation of the design rule violations superimposed on the mask layout data file.

29. The system of claim 21, wherein the DRC engine comprises a lookup table incorporating the plurality of design rules.

30. The system of claim 21 further comprising a network connection to a remote storage location.

31. The system of claim 30, wherein the remote storage location stores the mask layout data file.

32. The system of claim 30, wherein the remote storage location stores the plurality of design rules.

33. The system of claim 30, wherein the network comprises a local area network.

34. The system of claim 30, wherein the network comprises a wide area network.

35. The system of claim 21, further comprising a graphical user interface for allowing a user to control the system.

36. A system for performing a design rule checking (DRC) operation on a mask layout data file, the system comprising:
an input data manager for loading the mask layout data file into the system;
a DRC engine for applying a plurality of design rules to the mask layout data file, wherein the plurality of design rules are incorporated in a lookup table (LUT); and
an output data manager for generating an output data file.

37. The system of claim 36, the mask layout data file having a first data file format, wherein the input data manager further comprises means for converting the first data file format into a second data file format, the DRC engine being configured to operate on the second data file format.

38. The system of claim 37, wherein generating the output data file comprises converting the second data file format into a third data file format.

39. The system of claim 38, wherein the third data file format is the same as the first data file format.

40. The system of claim 38, wherein generating the output data file further comprises allowing a user to select the third data file format from a plurality of data file formats.

41. The system of claim 36, wherein the DRC engine generates a listing of design rule violations, and wherein the output data file comprises a graphical representation of the design rule violations superimposed on the mask layout data file.

42. The system of claim 36, wherein a first one of the plurality of design rules is based on a first shape, the first shape comprising a first edge and a second edge related according to a first property.

43. The system of claim 42, wherein the mask layout data file comprises a fractured data file, and wherein loading the mask layout data file into the system comprises reassembling a plurality of layout primitives into a plurality of polygons.

44. The system of claim 43, the mask layout data file comprising a plurality of layers, wherein loading the mask layout data file into the system comprises selecting at least one of the plurality of layers.

45. The system of claim 36 further comprising a network connection to a remote storage location.

46. The system of claim 45, wherein the remote storage location stores the mask layout data file.

47. The system of claim 45, wherein the remote storage location stores the plurality of design rules.

48. The system of claim 45, wherein the remote storage location stores the LUT.

49. The system of claim 45, wherein the network comprises a local area network.

50. The system of claim 45, wherein the network comprises a wide area network.

51. The system of claim 36 further comprising a graphical user interface for allowing a user to control the system.

52. A system for performing a design rule checking (DRC) operation on a mask layout data file, the system comprising:
means for loading the mask layout data file into the system;
means for applying a plurality of design rules to the mask layout data file, wherein a first one of the plurality of design rules is based on a first shape, the first shape comprising a first edge and a second edge related according to a defined property; and
means for generating an output data file.

53. The system of claim 52, wherein the mask layout data file comprises a fractured data file, and wherein the means for loading the mask layout data file into the system comprises means for reassembling a plurality of layout primitives into a plurality of polygons.

54. The system of claim 52, the mask layout data file comprising a plurality of layers, wherein the means for loading the mask layout data file into the system comprises means for selecting at least one of the plurality of layers.

55. The system of claim 52, the mask layout data file having a first data file format, wherein the means for loading the mask layout data file into the system comprises means for converting the first data file format into a second data file format, the DRC engine being configured to operate on the second data file format.

56. The system of claim 55, wherein the means for generating an output data file comprises means for converting the second data file format into a third data file format.

57. The system of claim 56, wherein the third data file format is the same as the first data file format.

58. The system of claim 55, wherein the means for generating an output data file further comprises means for allowing a user to select the third data file format from a plurality of data file formats.

59. The system of claim 52, wherein the DRC engine generates a listing of design rule violations, and wherein the output data file comprises a graphical representation of the design rule violations superimposed on the mask layout data file.

60. The system of claim 52, wherein the DRC engine comprises a lookup table incorporating the plurality of design rules.

61. The system of claim 52 further comprising means for accessing a remote storage location across a network.

62. The system of claim 61, wherein the remote storage location stores the mask layout data file.

63. The system of claim 61, wherein the remote storage location stores the plurality of design rules.

64. The system of claim 61, wherein the network comprises a local area network.

65. The system of claim 61, wherein the network comprises a wide area network.

66. The system of claim 52, further comprising a means for allowing a user to control the system.

67. The system of claim 66, wherein the means for allowing a user to control the system comprises a graphical user interface.

68. A system for performing a design rule checking (DRC) operation on a mask layout data file, the system comprising:
means for loading the mask layout data file into the system;
means for applying a plurality of design rules to the mask layout data file, wherein the plurality of design rules are incorporated in a lookup table (LUT); and
means for generating an output data file.

69. The system of claim 68, the mask layout data file having a first data file format, wherein the means for loading the mask layout data file into the system comprises means for converting the first data file format into a second data file format, the DRC engine being configured to operate on the second data file format.

70. The system of claim 69, wherein the means for generating the output data file comprises means for converting the second data file format into a third data file format.

71. The system of claim 70, wherein the third data file format is the same as the first data file format.

72. The system of claim 70, wherein the means for generating the output data file further comprises means for allowing a user to select the third data file format from a plurality of data file formats.

73. The system of claim 68, wherein the means for applying a plurality of design rules to the mask layout data file comprises means for generating a listing of design rule violations, and wherein the output data file comprises a graphical representation of the design rule violations superimposed on the mask layout data file.

74. The system of claim 68, wherein a first one of the plurality of design rules is based on a first shape, the first shape comprising a first edge and a second edge related according to a first property.

75. The system of claim 74, wherein the mask layout data file comprises a fractured data file, and wherein the means for loading the mask layout data file into the system comprises means for reassembling a plurality of layout primitives into a plurality of polygons.

76. The system of claim 68, the mask layout data file comprising a plurality of layers, and wherein the means for loading the mask layout data file into the system comprises means for selecting at least one of the plurality of layers.

77. The system of claim 68 further comprising means for accessing a remote storage location across a network.

78. The system of claim 77, wherein the remote storage location stores the mask layout data file.

79. The system of claim 77, wherein the remote storage location stores the plurality of design rules.

80. The system of claim 77, wherein the remote storage location stores the LUT.

81. The system of claim 77, wherein the network comprises a local area network.

82. The system of claim 77, wherein the network comprises a wide area network.

83. The system of claim 68 further comprising means for allowing a user to control the system.

84. The system of claim 79, wherein the means for allowing a user to control the system comprises a graphical user interface.
